(19) United States
(12) Patent Application Publication
(10) Pub. No.: US 2017/0132831 A1
(43) Pub. Date: May 11, 2017

(54) Hardware-Independent Display of Graphic Effects

(71) Applicant: Bayerische Motoren Werke Aktiengesellschaft, Muenchen (DE)

(72) Inventors: Sven VON BEUNINGEN, Muenchen (DE); Timo LOTTERBACH, Neufahrn (DE); Violin YANEV, Muenchen (DE); Jonathan CONRAD, Muenchen (DE); Serhat Eser ERDEM, Muenchen (DE)

(21) Appl. No.: 15/413,828

(22) Filed: Jan. 24, 2017

Related U.S. Application Data
(63) Continuation of application No. PCT/EP2015/066531, filed on Jul. 20, 2015.

(30) Foreign Application Priority Data
Jul. 25, 2014 (DE) 10 2014 214 666.6

(51) Int. Cl. G06T 15/00; B60K 35/00

(52) U.S. Cl. CPC G06T 15/005; B60K 35/00; G06T 2200/04; B60K 2350/2017; B60K 2350/352

(57) ABSTRACT

A method, and corresponding device, are provided to generate a graphic effect, in particular for a plurality of electronic devices. Them method determines the graphic content in which the graphic effect is to be used; calculates the graphic effect; generates a platform-independent model of the calculated graphic effect during run time; compiles the platform-independent model into a platform-dependent representation of the graphic effect; and displays the platform-dependent representation of the graphic effect on a display device.

### CROSS REFERENCE TO RELATED APPLICATIONS

This application is a continuation of PCT International Application No. PCT/EP2015/066531, filed Jul. 20, 2015, which claims priority under 35 U.S.C. §119 from German Patent Application No. 10 2014 214 666.6, filed Jul. 25, 2014, the entire disclosures of which are herein expressly incorporated by reference.

### BACKGROUND AND SUMMARY OF THE INVENTION

The invention relates to a method, a system and a computer program product for the hardware-independent display of graphic effects, in particular in a vehicle.

Vehicles contain microprocessor-controlled systems on which applications which generate three-dimensional (3-D) image data are executed. For this purpose, in the prior art, each application constructs a separate so-called scene model which describes a three-dimensional scene. So-called “renderers” are used to display the three-dimensional scene on a display unit. These systems may likewise be implemented on a microprocessor, in particular on a computer. They are used substantially to process the three-dimensional image data relating to the three-dimensional scene in such a manner that said data are adapted for display on the display unit.

During a rendering process, a two-dimensional image can be calculated from a three-dimensional scene, for example. In the case of the conversion of three-dimensional image data, the three-dimensional representation of an object, for example polygon meshes, can be converted into a pixel representation of the object in two-dimensional (2-D) computer graphics during the rendering process, for example.

A three-dimensional renderer can generate separate two-dimensional graphics from each individual three-dimensional scene, for example. An overall image for display on a display unit can be generated by means of a control component, a so-called layer manager, by superimposing different two-dimensional graphics. In this case, the individual two-dimensional images are placed on top of one another as layers according to a fixed sequence. In this case, contents from a higher level may cover contents from a lower level. The visibility of the contents of the uppermost layer can be guaranteed.

Such an architecture or data processing based on levels can be used to display three-dimensional contents of various applications on a common display (a display device). In this case, it is also possible to ensure that contents of a safety-relevant application are displayed on the display, that is to say they are not covered by contents of other applications which are not relevant to safety.

The display of three-dimensional contents requires interaction between the contents which include, for example, lighting effects, mirroring, shadowing and the like. These contents cannot be statically stored, like the two-dimensional contents, but rather must be calculated at run time.

If the intention is to use a graphic effect in different devices or device types, for example control devices or consumer terminals, a separate, that is to say platform-specific, shader must be developed for each device. This increases the development costs and greatly restricts flexibility, for example, with respect to the types of devices which can be used. Newly developed control devices or a new consumer terminal then cannot be used in a vehicle since a shader has not been developed for the new control device or consumer terminal in the vehicle. Consequently, particular contents can therefore be displayed only on devices which have been taken into account by the manufacturer at the time of developing the vehicle. This is disadvantageous, in particular, if newly developed consumer terminals are intended to be taken into account.

U.S. Pat. No. 8,289,327 B1 discloses the fact that parameters can be transferred to a shader at run time.

US 2002/0003541 A1 discloses the transfer of parameters to a hardware implementation of a shader using an API.

DE 11 2009 004 418 discloses a shader which can be downloaded.

DE 10 2009 007 334 A1 discloses the operation of downloading a shader.

DE 10 2013 201 377.9 (which relates to counterpart WO/2014/118145), the content of which is hereby incorporated by reference herein, discloses a method and an image processing system which at least partially superimposes three-dimensional image scenes and forms a three-dimensional overall scene. Three-dimensional output image data are also rendered.

The object of the invention is to provide a method and an apparatus which can generate graphic effects for a multiplicity of electronic devices.

The object of the invention is achieved by a method, a computer program product and a display system, according to embodiments of the invention.

A method for generating a graphic effect comprises determining a graphic content in which the graphic effect is to be used and calculating the graphic effect. According to the invention, a platform-independent model of the calculated graphic effect is generated at run time and the platform-independent model is compiled or translated into a platform-dependent representation of the graphic effect. Finally, the platform-dependent representation of the graphic effect is displayed on a display device, for example a central display device above the center tunnel of a vehicle, a combination instrument which is arranged behind the steering wheel, a display device projecting onto the windshield, or a consumer terminal. The graphic content may be a three-dimensional content. The platform-dependent description of the graphic effect may be pixel graphics.

This makes it possible to provide graphic information for output devices which are unknown at the development time using an abstract high-level language as an example of a platform-independent model. Graphic effects can be developed without special knowledge of the target hardware. Faster development cycles result in the mid term since not every item of target hardware has to be taken into account when developing a control device. Furthermore, the development can be carried out in a more abstract manner and there is no need for specialized personnel for the effect representation during each development. Furthermore, the disadvantages of the architecture based on levels are overcome.

The term “platform-dependent” can be interpreted as being dependent on the device type. Each device type may use a different description (for example instructions, pixel data, etc.) to process image data. Furthermore, adaptation to a particular individual device, for example an RGB correction, a gamma correction, etc., can be carried out before the platform-dependent representation is displayed.

The method also includes the step of transmitting the platform-independent model to an output device which is coupled to the display device. The step of compiling the platform-independent model into a platform-dependent representation of the graphic effect is carried out in the output device. The output device can be coupled to a plurality of devices or device types in order to display graphic contents with graphic effects.

The step of generating the platform-independent model of the calculated graphic effect at run time can be carried out by a control device of a vehicle, a mobile consumer terminal, a mobile telephone, a computer, a mobile computer, a tablet computer, a central server and the like. These devices, which can be coupled to the output device, communicate with the output device via a network inside the vehicle or a radio network, for example Bluetooth. The display device can output graphic contents from a plurality of devices. However, it is also possible for the display device to be implemented in a mobile consumer terminal, a mobile telephone, a mobile computer, a tablet computer or the like, with the result that these devices can reproduce graphic contents which are generated by the vehicle.

The graphic effect may be a lighting effect, a shadow effect, a mirror effect, blurring, transparency, semi-transparency, or an arrangement of partial scenes of the graphic content behind or above one another. Any desired other effects are possible.

The platform-independent model may be machine-independent, may use data structures, may use machine-independent data types and machine-independent instructions. Such criteria for a platform-independent model, for example for a high-level language, are known to a person skilled in the art and need not be explained in any more detail herein. The platform-independent model may use a machine-independent description of the graphic effect. This makes it possible to ensure that the graphic content and the graphic effect can be displayed on a multiplicity of terminals and display devices. The platform-independent model indicates safety-relevant graphic contents. The display device and the terminal can process these safety-relevant contents differently than contents which are not relevant to safety. A safety-relevant graphic content may be a warning of a malfunction of the brakes, a warning with regard to the oil level, the oil pressure, the tire pressure or the like.

The platform-independent model or the high-level language may have models with an abstract description of an effect. As a result, a person who is not skilled in the art in the field of implementing graphic effects can also generate graphic effects. The high-level language or the platform-independent model may use a different model for at least two graphic effects. The models can be combined with one another in any desired manner. There is preferably a separate model for each graphic effect. As a result, a developer of a user interface and the like can generate virtually any desired graphic effects on a multiplicity of terminals.

After the step of compiling the platform-independent model into a platform-dependent description of the graphic effect, a three-dimensional graphic content which includes the graphic effect can be converted into a two-dimensional representation which is displayed on a two-dimensional display device. This operation is also referred to as rendering.

The graphic content may have at least one element of a user interface of a computer program, the entire user interface of a computer program, a symbol, a pictogram, a representation of at least one component of a vehicle, a representation of at least one object outside the vehicle, a navigation map or the like. The contents mentioned may be three-dimensional. The graphic content may include any desired objects which are defined by a polygon mesh, vector graphics or another geometry description.

The invention also relates to a computer program product which, when loaded into a memory of at least one computer, carries out the steps of the method described above.

The invention also relates to a display system which is designed to display graphic contents on a display device in a vehicle. The display system includes an output device which can be coupled to an electronic device. The electronic device is designed to determine a graphic content in which a graphic effect is to be used. The electronic device can calculate the graphic effect. According to the invention, the electronic device generates a platform-independent model of the calculated graphic effect at run time. The output device is designed to compile the platform-independent model into a platform-dependent representation of the graphic effect and to display the platform-dependent representation of the graphic effect on a display device.

The display system may be developed in the manner described above with respect to the method.

The output device need not necessarily be implemented by the vehicle. The output device may be implemented by a mobile consumer terminal, a mobile telephone, a computer, or a mobile computer which displays a graphic content which has been generated using means of the vehicle.

For example, the electronic device includes a control device of a vehicle, a mobile consumer terminal, a mobile telephone, a mobile computer, a tablet computer or the like.

The invention also relates to a vehicle having the display system.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of selected components of an electronic system of a vehicle.

FIG. 2 is a schematic diagram of the method according to an embodiment of the invention.

FIG. 3 is an example of a platform-independent model.

### DETAILED DESCRIPTION OF THE DRAWINGS

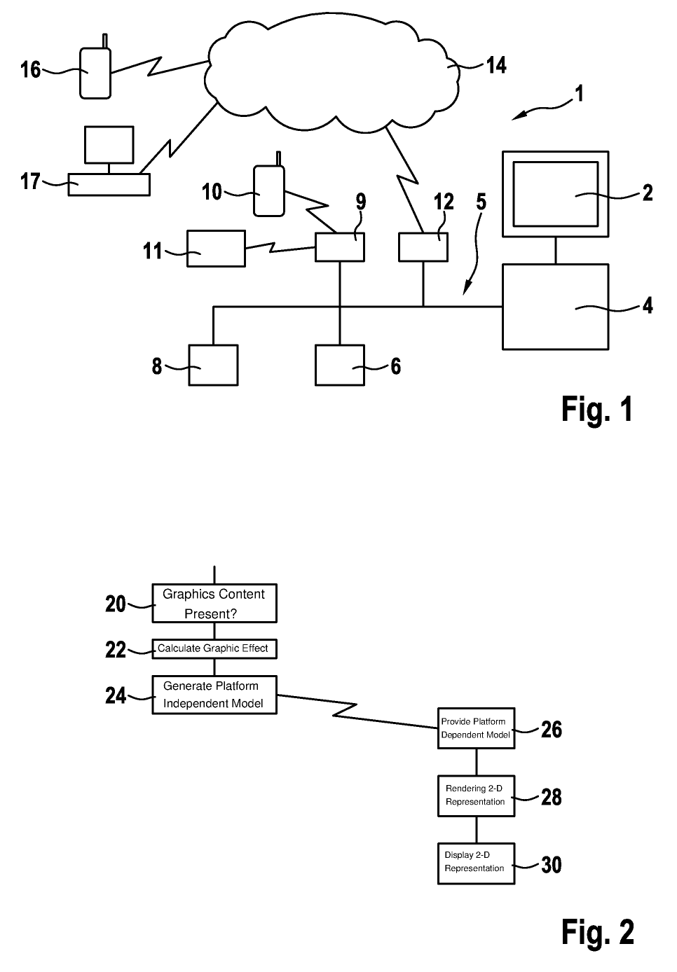

FIG. 1 shows part of an electronic system 1 of a vehicle. The vehicle includes a display device, for example a screen, a combination instrument which is arranged behind a steering wheel, a central display device which is arranged above a center tunnel of the vehicle, a display device projecting onto the windshield (head-up display) or the like. An output device 4 is connected to the display device 2. The output device 4 can preprocess contents for a plurality of electronic devices in the vehicle, which contents are displayed on the display device 2. The plurality of electronic devices are connected to the output device 4 via a bus 5.

The vehicle includes a monitoring device 6 which monitors, for example, the oil level, the oil pressure, the tire pressure, the coolant temperature or the like. As soon as a warning needs to be output on the display device 2, the warning device 6 transmits a graphic content, which may include a symbol and optionally operating elements, to the output device 4. The output device 4 displays the graphic content on the display device 2. The vehicle also includes an entertainment device 8 which may be a radio, a music playback system or the like. The entertainment device 8 can output graphic contents, which are needed to operate the entertainment device 8 and also include symbols and optional operating elements, to the output device 4 which displays the graphic contents on the display device 2.

The vehicle includes a first coupling device 9 to which a mobile telephone 10 and/or a mobile computer 11, for example a tablet computer, can be coupled. The mobile telephone 10 and/or the mobile computer 11 can output graphic contents on the display device 2 via the coupling device 9 and the output device 4. The mobile telephone 10 and/or the mobile computer 11 can be coupled to the coupling device 9 by means of a radio network, for example Bluetooth.

However, it is also possible for an internal device of the vehicle, for example the monitoring device 6 and/or the entertainment device 8, to output a graphic content on the mobile telephone 10 and/or on the mobile computer 11 via the coupling device 9.

Furthermore, a second mobile telephone 16, which is outside the vehicle, and a computer 17, which is outside the vehicle, can be coupled to a second coupling device 12 of the vehicle 1 via a network 14, for example a mobile radio network. An electronic device inside the vehicle can display graphic contents on an electronic device outside the vehicle. However, it is also possible for an electronic device outside the vehicle to display a graphic content on the display device 2 by way of the output device 4.

For example, the monitoring device 6 may display a graphic content on a mobile telephone 16 or a computer 17, which are outside the vehicle, via the second coupling device 12 and the mobile radio network. This information may include, for example, a warning of an excessively low filling level of a fuel. However, it is also possible for a computer 17, which is outside the vehicle, or a mobile telephone 16, which is outside the vehicle, to display an item of graphic information on the display device 2 by way of the output device 4 via the network 14 and the second coupling device 12.

The method of operation of the invention is explained in detail by means of additional reference to FIG. 2. A step 20 determines whether a graphic content in which a graphic effect is to be used is present. A suitable communication mechanism, for example intra-process communication, inter-process communication or the like, can be used to transfer data in which the graphic effect is to be used.

The graphic effect is calculated in a step 22. This step may include, for example, generating suitable parameters for representing the graphic effect. A platform-independent model of the graphic effect is generated at run time in a step 24. The platform-independent model may include a machine-independent description of the graphic effect. The platform-independent model may indicate safety-relevant graphic contents. The platform-independent model may include a model with an abstract description of an effect. The platform-independent model may use different models for different effects, the models being able to be combined with one another.

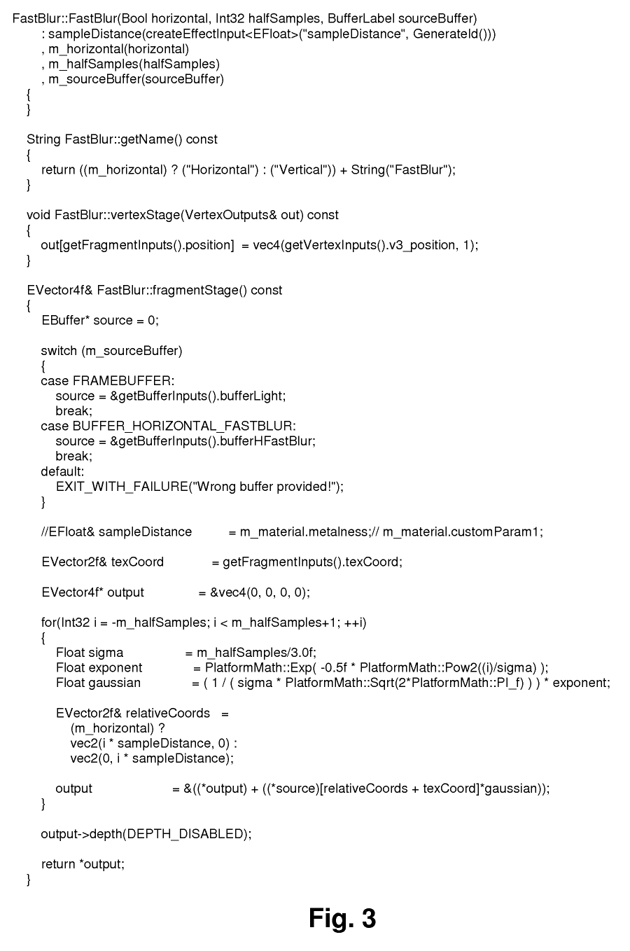

The platform-independent model may be designed, for example, like a high-level language for representing the graphic content, as shown in FIG. 3.

The effect described by means of pseudocode in FIG. 3 may implement blurring. The “fragmentStage” and “vertexStage” methods are important parts for generating the blurring. The operations illustrated in FIG. 3 with regard to normal data types, for example “float” (floating-point number), are values which are locally precalculated during instantiation of a respective class. All data types which start with “E”, for example EVector4, are data types which can only be calculated in the graphics hardware.

Steps 20 to 24 can be carried out by a device inside the vehicle which is permanently installed in the vehicle or is brought into the vehicle by a user as a mobile device during use of the vehicle. However, steps 20 to 24 can also be carried out by an electronic device outside the vehicle, which is intended to display a bad weather warning in the vehicle, for example.

The platform-independent model of the graphic effect generated in step 24 is transmitted to the output device 4 or to a mobile telephone 10 inside the vehicle, a mobile computer 11 inside the vehicle, a mobile telephone 16 outside the vehicle and/or a computer 17 outside the vehicle. Steps 26 to 30 are carried out there. In step 26, the platform-independent model of the graphic effect is converted, compiled or translated into a platform-dependent description of the graphic effect. The method of operation of a compiler or translator is known to a person skilled in the art and need not be described in any more detail herein.

In step 28, an item of three-dimensional information containing the graphic effect is converted into a two-dimensional representation in order to be displayed on a two-dimensional display device 2 or a terminal 10, 11, 16, 17 having a two-dimensional display device (screen). This is also referred to as rendering.

In step 30, the two-dimensional information is displayed on the display device 2 or on a mobile terminal 10, 11, 16, 17.

The output device 2 need not necessarily be implemented by the vehicle. The output device may be implemented by a mobile consumer terminal, a mobile telephone, a computer or a mobile computer which displays a graphic content which has been generated using means of the vehicle.

The invention has the advantage that effects can be developed and generated without taking into account the target hardware and without the need for special knowledge of the target hardware. This results in faster development cycles since the target hardware does not need to be considered as strongly during implementation. Higher abstraction of the effects makes it possible for less specialized personnel to implement effects. Furthermore, effects can be combined in an automated manner according to properties of the target hardware in order to enhance performance.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for generating a graphic effect, the method comprising steps of:
determining a graphic content in which the graphic effect is to be used;
calculating the graphic effect;
generating a platform-independent model of the calculated graphic effect at run time;
compiling the platform-independent model into a platform-dependent representation of the graphic effect; and
displaying the platform-dependent representation of the graphic effect on a display device.

2. The method as claimed in claim 1, further comprising the step of:
transmitting the platform-independent model to an output device which is coupled to the display device; and
wherein the step of compiling the platform-independent model into a platform-dependent representation of the graphic effect is carried out in the output device.

3. The method as claimed in claim 1, wherein the step of generating the platform-independent model of the calculated graphic effect at run time is carried out by at least one of the following:
a control device of a vehicle;
a mobile consumer terminal;
a mobile telephone;
a computer;
a mobile computer;
a tablet computer; or
a central server.

4. The method as claimed in claim 1, wherein the graphic effect comprises at least one of the following effects:
a lighting effect;
a shadow effect;
a mirror effect;
blurring;
transparency;
semi-transparency; or
an arrangement of partial scenes of the graphic content behind or above one another.

5. The method as claimed in claim 3, wherein the graphic effect comprises at least one of the following effects:
a lighting effect;
a shadow effect;
a mirror effect;
blurring;
transparency;
semi-transparency; or
an arrangement of partial scenes of the graphic content behind or above one another.

6. The method as claimed in claim 1, wherein the platform-independent model has one of the following criteria:
the platform-independent model is machine-independent;
the platform-independent model uses data structures;
the platform-independent model uses machine-independent data types;
the platform-independent model uses machine-independent instructions;
the platform-independent model uses a machine-independent description of the graphic effect;
the platform-independent model indicates safety-relevant graphic contents;
the platform-independent model uses models with an abstract description of a graphic effect; or
the platform-independent model uses a different model for at least two graphic effects, the models being able to be combined with one another.

7. The method as claimed in claim 5, wherein the platform-independent model has one of the following criteria:
the platform-independent model is machine-independent;
the platform-independent model uses data structures;
the platform-independent model uses machine-independent data types;
the platform-independent model uses machine-independent instructions;
the platform-independent model uses a machine-independent description of the graphic effect;
the platform-independent model indicates safety-relevant graphic contents;
the platform-independent model uses models with an abstract description of a graphic effect; or
the platform-independent model uses a different model for at least two graphic effects, the models being able to be combined with one another.

8. The method as claimed in claim 1, wherein, after the step of compiling the platform-independent model into a platform-dependent representation of the graphic effect, the following step is carried out:
converting a three-dimensional graphic content into a two-dimensional representation which is displayed on the display device.

9. The method as claimed in claim 7, wherein, after the step of compiling the platform-independent model into a platform-dependent representation of the graphic effect, the following step is carried out:
converting a three-dimensional graphic content into a two-dimensional representation which is displayed on the display device.

10. The method as claimed in claim 1, wherein the graphic content comprises at least one of the following:
at least one element of a user interface of a computer program;
an entire user interface of a computer program;
a symbol;
a pictogram;
a representation of at least one component of a vehicle;
a representation of at least one object outside the vehicle; or
a navigation map.

11. The method as claimed in claim 9, wherein the graphic content comprises at least one of the following:
at least one element of a user interface of a computer program;
an entire user interface of a computer program;
a symbol;
a pictogram;
a representation of at least one component of a vehicle;
a representation of at least one object outside the vehicle; or
a navigation map.

12. A computer program product, comprising a non-transitory computer readable medium having stored therein instruction which, when executed on a computer, carry out the method of claim 1.

13. A display system which is designed to display graphic contents on a display device in a vehicle, comprising:
an output device which is coupleable to an electronic device,
wherein the electronic device is designed to determine a graphic content in which a graphic effect is to be used, to calculate the graphic effect and to generate a platform-independent model of the graphic effect of the calculated graphic effect at run time, and
the output device is designed to compile the platform-independent model into a platform-dependent representation of the graphic effect and to display the platform-dependent representation of the graphic effect on a display device.

14. The display system as claimed in claim 13, wherein the electronic device comprises at least one of the following:
a control device of a vehicle;
a mobile consumer terminal;
a mobile telephone;
a computer;
a mobile computer; or
a tablet computer.
